(19) United States
(12) Patent Application Publication
(10) Pub. No.: US 2014/0320684 A1
(43) Pub. Date: Oct. 30, 2014

(54) Universal Control Unit and Display With Non-Contact Adjustment Functionality

(71) Applicants: David Chatenever, Santa Barbara, CA (US); Marc R. Amling, Santa Barbara, CA (US)

(72) Inventors: David Chatenever, Santa Barbara, CA (US); Marc R. Amling, Santa Barbara, CA (US)

(21) Appl. No.: 14/329,595

(22) Filed: Jul. 11, 2014

Related U.S. Application Data
(63) Continuation-in-part of application No. 11/695,960, filed on Apr. 3, 2007, now Pat. No. 8,810,637.

(51) Int. Cl. H04N 5/232

(52) U.S. Cl. CPC H04N 5/23225
USPC 348/211.4

(57) ABSTRACT

An endoscopic video system that provides for multiple differing inputs from a plurality of different attached devices, the control automatically sensing and configuring itself based upon the connected devices (e.g. camera or display). The system further provides for non-contact adjustment of the system by use of gesture control such that image data capture and routing, display settings, surgical equipment and/or tools can be accomplished without the need of physically touching a control interface.

### FIELD OF THE INVENTION

The invention relates to a multi-function camera control unit, and more particularly, to a camera control unit that is capable of functioning with multiple different types of cameras and programmable displays and where control and updating of the display can occur from the camera control unit.

### BACKGROUND OF THE INVENTION

A Camera Control Unit (“CCU”) is generally used in conjunction with a camera to capture and process images. The camera may include Charge Couple Devices (“CCD”), Complementary Metal-Oxide-Semiconductor (“CMOS”) devices or any other type of image capture device. They are typically used in conjunction with an endoscope to generate image data of an area to be viewed during a surgical procedure. The image data is transmitted to the CCU. The CCU then processes the image data into displayable image data to be sent to a display. The CCU may also send commands to the camera in order to operate and adjust camera settings.

Known CCUs typically control a single type of camera by receiving and processing image data generated by the camera. The CCU controls the camera by adjusting color balance, light, focal distance, resolution, zoom, focus, shading, and other typical optical characteristics.

Traditionally, CCUs have been compatible with a limited number of devices because the control unit hardware, through which commands were sent and image signals were received, was difficult to configure to communicate with the many different types of devices in the market. For example, different devices may have varying electronic requirements/connections in order to function properly. Devices may be either analog or digital. In addition, some types of cameras are designated to pick up certain colors such as red or green while others pick up blue. In addition, as changes and improvements are made to devices, a control unit's hardware, which was configured to be compatible with older devices, may become incompatible and may need to be upgraded as well.

Because a CCU was compatible with limited quantities of devices, older CCUs were typically discarded in favor of CCUs that were made concurrently with particular devices. In order to address compatibility problems, configurable CCUs were introduced to function with a number of differing camera types.

For example, U.S. Pat. No. 5,627,583 (“Nakamura et al.”) relates to an electroendoscope system that is compatible with a plurality of different endoscope types. However, Nakamura et al. fails to teach, disclose or suggest a system that is compatible with fundamentally differing signal types, such as for instance, a standard definition and a high-definition signal format. In addition, Nakamura et al. fails to teach or suggest a system that is compatible or usable with numerous differing display types, such as for instance, standard definition and high-definition displays. Therefore, while Nakamura et al. does provide for some versatility with regard to the attached camera, e.g. can configure itself to control the attached camera and receive the generated image signal, the CCU taught in Nakamura et al. is still limited to being able to receive a single type of image signal input (e.g. an analog input) and a single image signal format output (See, Col. 3, ln. 60-Col. 4, ln. 4; Col. 4, lns. 58-67).

As video surgery increasingly becomes the norm, the quality of the displays becomes more important as does the ability to control the quality of the displayed image. It is typical that multiple monitors are used during a surgical procedure. For example, a large main surgical monitor may be positioned in a location for easy viewing by the surgeon performing the procedure. In addition, other surgical monitors may be placed in positions that allow other medical personnel to conveniently view the procedure. Likewise, still other monitors may be used in the operating room to display other data and information to the medical personnel. Control of these monitors typically can be achieved by the activation of a button(s) on the side or bottom of the display to adjust various parameters relating to the particular display. However, often the displays are not sterile, so adjustment must occur by someone that must then re-sterilize or be performed by someone that is not sterilized.

Additionally, the advent of touch screen monitors has provided great versatility for surgical teams. The ability to see the settings of various surgical equipment and tools and then adjust various the settings on the same screen they are displayed is highly desirable. However, this requires that the touch screen be maintained in the sterile environment and be sterilized regularly. The sterilization process can be harsh, leading to a shortening of the life of the equipment, and/or equipment that need be sterilizable is typically much more costly to manufacture. Likewise, the space in the sterile environment is very limited.

A tension is therefore presented with respect to the medical displays. On the one hand, it is desirable to place the displays very close to the sterile environment and convenient for the surgeon to view. Likewise, control of the displays and control of devices/tools/etc via, for example, is also desirable, but this requires the displays to be located in the sterile environment and to be able to be sterilized. This takes up valuable space, increases the cost of the displays and requires a great deal of work to keep the displays sterilized from procedure to procedure.

### SUMMARY OF THE INVENTION

What is desired, therefore, is to provide a system and method that is capable of maintaining compatibility different devices that may have fundamentally different signal formats.

It is also desired to provide a system and method that can automatically detect the type of device attached and can then automatically configure itself to be compatible with and control the attached device.

It is further desired to provide a system and method that is compatible with many different types of displays.

It is still further desired to provide a system and method that can automatically detect the type of connected display and can then automatically configure itself to be compatible with and control the attached display.

It is yet further desired to provide a system and method that can receive information from a connected device and automatically detect whether the received information is most up-to-date information for the attached device and if not, provide upgraded information to the attached device.

It is still further desired to provide a system and method that can accept either a standard or a high definition input signal from an input device and provide either a standard or a high definition output signal for an attached output device.

It is additionally desired to provide a system and method that allows for an attached medical display to be adjusted without need of touching the display.

Likewise, it is desired to provide a system and method that allows for the display of settings for various medical devices and/or tools and allows for control or adjustment of the settings of the various medical devices and/or tools without need of touching the display.

These and other objects are achieved in one advantageous embodiment in which a video imaging system is provided including a CCU the can automatically sense and identify a connected device, such as a camera or a display, the CCU configuring and/or programming itself based on the identified device. A camera is provided to receive reflected light from an area to be viewed and for generation of image data representative of the reflected light. There are many different types of cameras and a number of different signal formats for the image data including, for example, Standard Definition (SD) and High Definition (HD) signals. In order to configure itself, the CCU retrieves and/or receives a program or multiple programs stored on a storage device. The retrieved program(s) execute on the camera control unit for enabling the camera control unit to process the image data. The digital input signal from an attached camera can vary widely, for example they may include but not are limited to ranges from 200×200 pixel resolution to 1920×1080 pixel resolution.

It is contemplated that the storage device may be any type of storage medium accessible by the control unit. For instance, it may be an internal, external, or removable drive and may also include a remote location, such as an Internet location. The storage device may also be located within the camera and/or the CCU. It is further contemplated that multiple storage devices and/or locations may be used to provide the latest version of software and/or programs for the configurable control unit.

In addition, the CCU also senses and identifies a connected display and configures an output signal to be compatible with the identified display. The output signal may variously be compatible with, for example, NTSC or PAL formats and may be provided as an SD or an HD signal. In addition to providing a compatible video signal output to an attached display, the CCU configures output control signals to properly control the attached display. Control of the display could include any of the functionality relating to the display the surgeon would like to adjust, including for example, the brightness/contrast, color settings, horizontal and vertical positioning, sharpness, pixel clock, phase, dynamic contrast, energy modes of operation, language, menu timers, Display Data Channel/Command Interface (DDC/CI), LCD Conditioning, or even personalized short cuts for controls (collectively the “display control settings”).

The CCU may be provided as a field programmable gate array (e.g. a configurable hardware device) or may be provided as a microprocessor or a Digital Signal Processor (DSP) (e.g. a soft configurable device). In any event, the CCU detects and identifies the connected device, e.g. a particular camera and/or a particular display, storage or other device, and configures itself to be compatible with the connected devices both for function and control. To function properly with a camera, the CCU will configure itself so as to be able to receive image data from and to be able to send command signals to the camera to control, for example, the camera's optical functional characteristics including: focal distance, resolution, light balance or color and the like.

In one advantageous embodiment, the CCU is provided with a microprocessor that receives a processor program for programming the microprocessor and a device program for programming and/or configuring the configurable device to process the received image data.

The programmable CCU is further provided to function with a programmable display. In this instance, the display include a program comprising, for example, firmware that allows for control of the display from the CCU. As previously stated, control of the display could include any display control settings the surgeon would like to adjust. It is contemplated that any or all of the display control settings can be adjusted from the CCU such that the display or any of the connected displays, can be adjusted without the need to physically touch the display. This is advantageous in that if a surgeon would like to adjust a display setting at the start or during a surgical procedure, such an adjustment will be possible without having to touch a button on the display (which may not be sterile) and thereby delay the surgical procedure as the individual sterilizes again.

Likewise, the program or firmware that is stored on the display can be updated from, for example, the CCU such that updates can be accomplished remotely over a network connection at a time when the display is not in use.

Additional functionality that can be provided with the programmable display includes gesture control. For example, a programmable display could include a camera build in that picks up gestures made by a surgeon for control. The programmable display could utilize infrared, ultrasonic or any other well-known technique for picking up hand gestures for interpretation. It is contemplated that the camera used for picking up the gestures would be built entirely within the surgical display obviating the need for external sensors (e.g., placed above or below the surgeon). The gesture control could be used to control virtually any of the surgical system functionality including, but not limited to, image capture (still images and video clips), image routing, audio recording, which may or may not be associated with image data, surgical equipment settings, surgical tool(s) control, operating room equipment (e.g., lighting levels, blinds/shades positioning, environmental controls, etc.), display control settings and so on. The previous examples are presented to further illustrate and explain the system and should not be taken as limiting in any regard.

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The term “network” as used herein includes both networks and internetworks of all kinds, including the Internet, and is not limited to any particular network, inter-network, or intra-network.

The terms “coupled”, “coupled to”, and “coupled with” as used herein each mean a relationship between or among two or more devices, apparatus, files, programs, media, components, networks, systems, subsystems, and/or means, constituting any one or more of (a) a connection, whether direct or through one or more other devices, apparatus, files, programs, media, components, networks, systems, subsystems, or means, (b) a communications relationship, whether direct or through one or more other devices, apparatus, files, programs, media, components, networks, systems, subsystems, or means, and/or (c) a functional relationship in which the operation of any one or more devices, apparatus, files, programs, media, components, networks, systems, subsystems, or means depends, in whole or in part, on the operation of any one or more others thereof.

In one advantageous embodiment, a video endoscopic system is provided comprising, a camera for generating image data and a display for displaying the image data. The system further comprises a camera control unit coupling the camera to the display.

In another advantageous embodiment, a method for transmitting image data from multiple cameras having differing signal formats to a camera control unit and a display is provided comprising the step of providing, a first receptacle and a second receptacle in the camera control unit, the first receptacle having a first configuration and the second receptacle having a second configuration that is different from the first configuration. The method further comprises the steps of providing a camera having one of either a first plug configuration or a second plug configuration that couples to the first and second receptacle configurations respectively, coupling the camera to one of the first or second receptacles and receiving a camera identifier and a program. The method still further comprises the steps of configuring the camera control unit based on the camera identifier and received program, coupling the camera control unit to the display and receiving a display identifier. Finally, the method comprises the steps of configuring an output signal to be compatible with the connected display, transmitting image data to the display and displaying the image data on the display.

In an advantageous embodiment, a surgical system is provided comprising a camera for generating image data and a control unit connected to said camera. The control unit is configured to function with at least two different displays, each of the at least two different displays having differing input signal requirements and each of the at least two different displays having a storage including a display identifier identifying the respective display. The system is provided such that upon connection of the control unit with one of the at least two different displays, the control unit automatically determines a compatible output signal format for the connected display and configures itself accordingly.

In another advantageous embodiment a surgical system is provided comprising, a camera for generating image data and a display for displaying the image data, the display having a storage with a display identifier saved therein. The display includes a camera located therein. The surgical system further comprises, a control unit having a gesture control module, the control unit coupling the camera to the display. The system is provided such that upon connection of the control unit with the display, the control unit automatically determines a compatible output signal format for the connected display and configures itself accordingly, and the camera picks up gestures made to control the system.

Other objects of the invention and its particular features and advantages will become more apparent from consideration of the following drawings and accompanying detailed description.

### BRIEF DESCRIPTION OF THE DRAWINGS

FIG. 1 is a block diagram of one advantageous embodiment of the present invention.

FIG. 2 is a block diagram of the advantageous embodiment according to FIG. 1.

FIG. 3 is a block diagram of the advantageous embodiment according to FIG. 1.

FIG. 4 is a block diagram of the advantageous embodiment according to FIG. 1.

FIG. 5 is an illustration of the Camera Control Unit according to the advantageous embodiment of FIG. 1.

FIG. 6 is an illustration of the Camera Control Unit according to the advantageous embodiment of FIG. 1.

FIG. 7 is an illustration of input and output dimension for HD project resampling for NTSC.

FIG. 8 is an illustration of input and output dimension for HD project resampling for PAL.

FIG. 9 is a block diagram of the advantageous embodiment according to FIG. 1.

FIG. 10 is a block diagram of an advantageous embodiment according to FIG. 1.

### DETAILED DESCRIPTION OF THE INVENTION

Referring now to the drawings, wherein like reference numerals designate corresponding structure throughout the views.

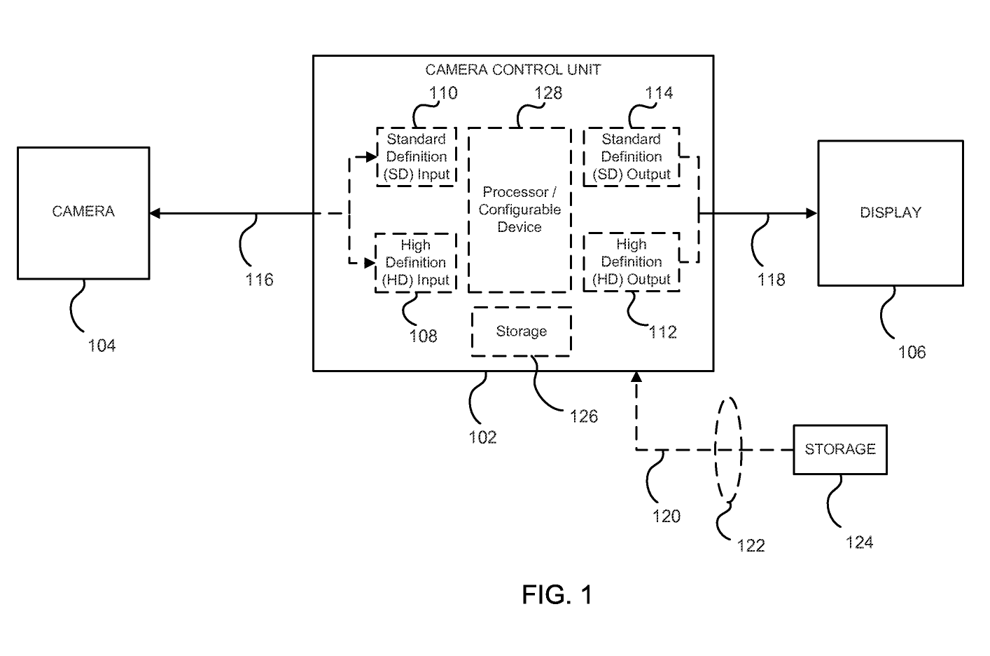

FIG. 1 depicts a system 100 comprising a camera 104 for generating image data. Camera 104 is connected to camera control unit 102 via a coupling 116. The coupling 116 is provided to supply electrical power to camera 104 as well as to transmit data between camera 104 and camera control unit 102. Camera control unit 102 is provided with at least two different inputs, including, a High-Definition (HD) Input 108 and a Standard-Definition (SD) Input 110. As used in this application, SD generally refers to a line count of up to approximately 720×480 NTSC and PAL; while HD refers to systems that utilize a higher line count and may include, for example but not limited to, 1280×720 progressive or 1920×1080 or interlaced, which are only two of the commonly used HD resolutions. Depending on the camera type (SD or HD) a user will attach the camera to either the HD input 108 or the SD input 110.

Also shown in FIG. 1 is processor/configurable device 128 shown in camera control unit 102. Based on the connected camera, the camera control unit 102 will be configured to function with the connected camera 104 via either the HD input 108 or the SD input 110.

Two different output types are illustrated in FIG. 1 including, HD output 112 and SD output 114. It is contemplated that a display 106 may be connected to camera control unit 102 via a coupling 118. Upon connection, the camera control unit 102 can detect the attached display 106 and determine the correct signal format for proper functioning of display 106. For example, display 106 may be designed to display only SD video signals. That being the case, camera control unit 102 will transmit an SD signal format to display 106 whether an SD or an HD camera is connected. Alternatively, it may be determined that the connected display 106 may be designed to display HD video signals. In this case, if the connected camera 104 is an HD camera, an HD signal is transmitted to display 106. If however, an SD camera 104 is connected to camera control unit 102, an enhanced SD signal may be transmitted to the HD display 106. In this manner the following signal format types may be used SDᵢₙₚᵤₜ→SDₒᵤₜₚᵤₜ; SDᵢₙₚᵤₜ→Enhanced SDₒᵤₜₚᵤₜ; HDᵢₙₚᵤₜ→SDₒᵤₜₚᵤₜ; and HDᵢₙₚᵤₜ→HDₒᵤₜₚᵤₜ. It should be noted that categorization of inputs and outputs as SD or HD is not intended to limit the categories to a single signal format, but rather, many differing signal formats may be categorized as SD and many differing signal formats may be categorized as HD.

It is contemplated that configuration information for either camera 104 and/or display 106 may be located on camera 104 and display 106 respectively. Alternatively, configuration information may be located in storage 126 that may comprise an internal storage device for camera control unit 102 with camera 104 and display 106 providing an identifier for camera control unit 102 to look up the correct configuration information. Still further, configuration information may be remotely located and may be transmitted to camera control unit 102 via a line 120 over a network connection 122 from a remote storage 124. The network connection 122 may include, for example, an Intranet, the Internet and/or the like.

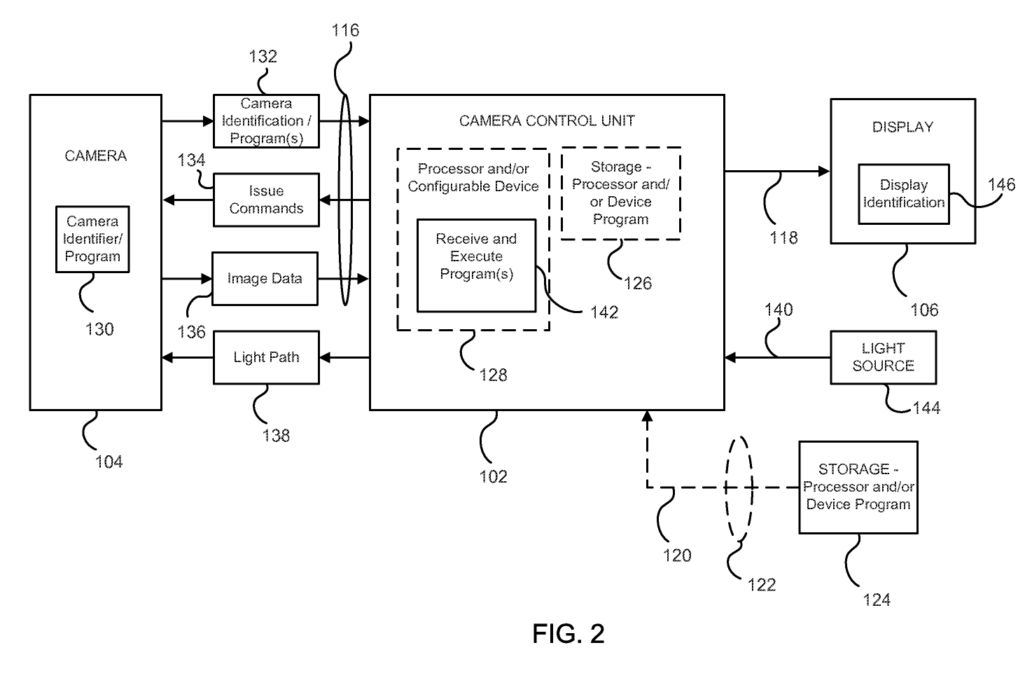

Referring now to FIG. 2, an advantageous embodiment of the interaction between camera 104 and camera control unit 102 is illustrated. For example, upon connection of camera 104 to camera control unit 102, a camera identifier/program 130 stored on camera 104 may be transmitted as camera information/program(s) 132 to camera control unit 102. It is contemplated that the camera identifier may comprise discrete data or may comprise a program. In addition, it is contemplated that one or more programs may be stored on camera 104 and transmitted as or with the camera identification data. The processor and/or configurable device 128 receives the camera information/program(s) and executes the program(s) 142, which allows the processor and/or configurable device 128 to receive and process image data generated and transmitted by camera 104.

It is further contemplated that one or more programs may be located on internal storage 126 or may be located on remote storage 124. For example, upon connection of camera 104 to camera control unit 102, camera identifier 130 may be transmitted to camera control unit 102. Once identified, a program(s) may be transmitted to processor and/or configurable device 128 from camera 104, internal storage 126 or remote storage 124.

Once processor and/or configurable device 128 is properly configured to function with camera 104, camera control unit 102 may issue commands 134 to camera 104, for example, to adjust color balance, light, focal distance, resolution, zoom, focus, shading, and other optical characteristics. Camera 104 may then generate and transmit image data 136, which is received and processed by camera control unit 102. Image data received and processed by camera control unit 102 is then transmitted in the proper signal format to display 106.

Also illustrated in FIG. 2 is light path 138, 140 and light source 144. It is contemplated that light source 144 may comprise virtually any type of commonly used light source including, for example, a Light Emitting Diode while the light path may comprise, for instance, a coherent or non-coherent fiber optic bundle. While the light path 138, 140 is illustrated passing through camera control unit 102, it is contemplated that the light path may be separate and apart from camera control unit 102. Additionally, it is contemplated that light path 138 may be combined into coupling 116 or light source 144 may be provided in camera 104, or camera control unit 102.

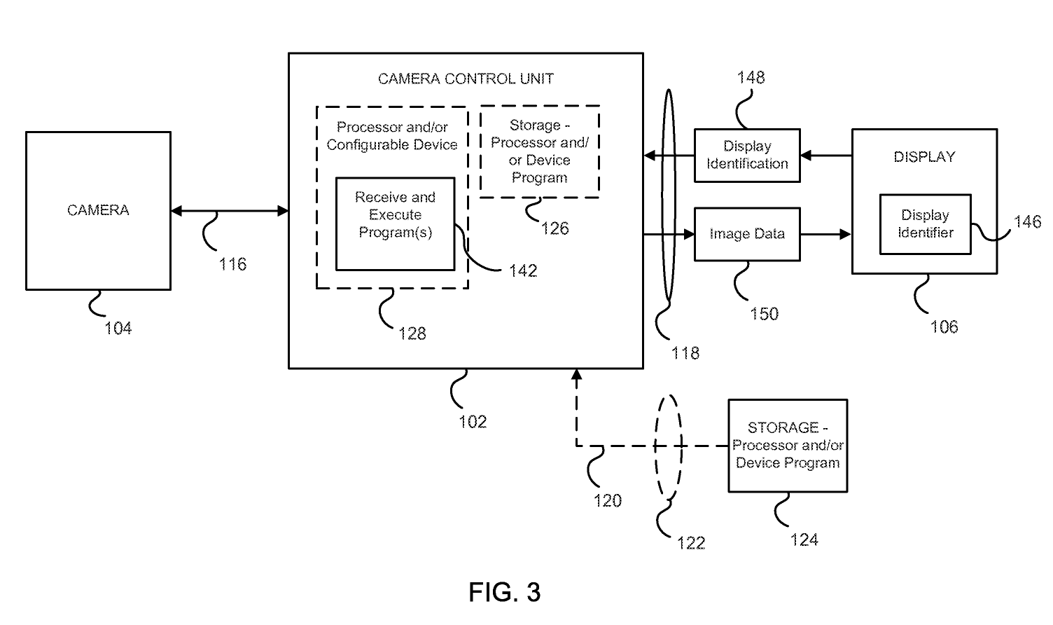

FIG. 3 illustrates still another advantageous embodiment of the present invention. In this embodiment, display identifier 146 stored on display 106 is transmitted as display identification 148 to camera control unit 102. Once received, camera control unit 102 will determine a signal format that will be compatible with display 106. Image data 150 will then be transmitted to display 106 in the properly configured signal format.

There are commonly used types of signal formats that are typically used, however, it is contemplated that additional formats may be provided for and especially new signal formats that may become available. The two commonly used SD format types are NTSC and PAL. It should be noted that these are just two video signal formats and that there are many differing types and modifications to the above-listed types including, for example, a modified version Phase-Alternating Line (PAL-M). In any event, upon receipt of display information 148, camera control unit 102 can retrieve information and/or a program from, for example, internal storage 126, remote storage 124 or even from display 106 for configuration of the output signal for sending image data 150 in the proper format.

A number of examples will be provided of the input and output dimensions for HD resampling of NTSC and PAL formats. The following examples are presented to further illustrate and explain the present invention and should not be taken as limiting in any regard.

### Example 1

For NTSC the specifications in one advantageous embodiment are as follows:

Active data: 484×756

Pixel dimensions: 4.75 H×5.55 V

FPS: 60/1.001=59.9401

Data stream (input and output) is running at 147.2727 MHz.

Dimensions of Total Input Data (Active and Inactive).

Total number of input lines: 525. To find the total number of pixels per line: in 1 second there are 145.2727×10⁶ pixels. Also, in 1 second there are 60/1.001 frames of (525×total number of pixels per input line (145.2727×10⁶/((60/1.001)×525)=4680.

Dimensions of Total Output Data (Active and Inactive).

Total number of output lines: 1125. We can use the fact that the input and output frame correspond to the same frame time. The total number of pixels per output line is then: (525×4680)/1125=2184.

Dimensions of Active Input Data.

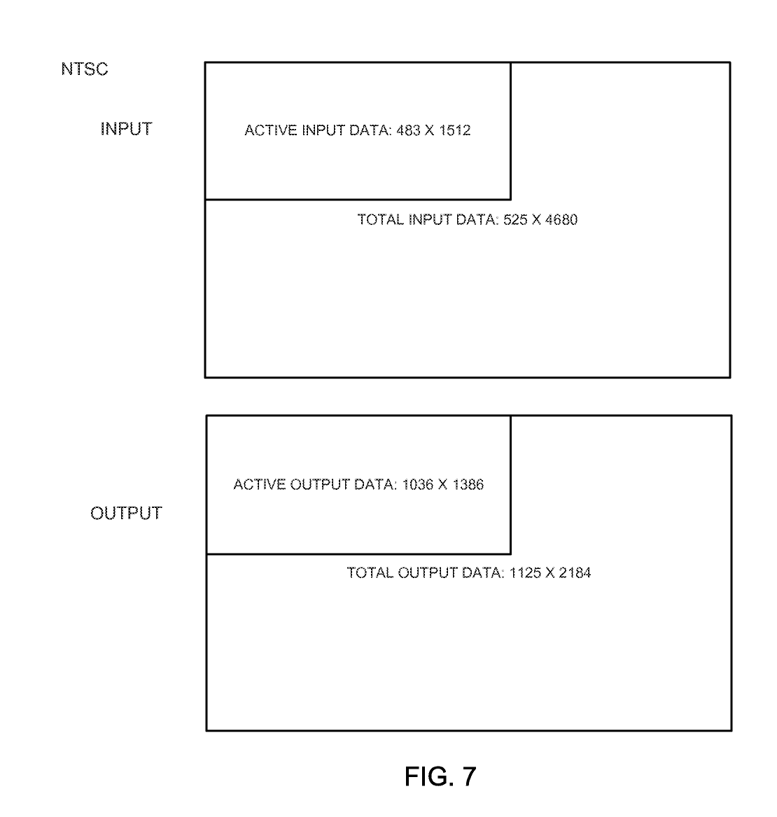

Out of a total of 525 lines, we assume that 483 contain valid data (active lines). The number of input active lines is: 483. The number of pixels per active line is: 756 oversampled by 2=1512. The active lines need to be resampled (vertically) by a factor of 1125/525. The number of output lines is: 483× 1125/525=1035. It should be noted that, in this case, 1125/525 gives an integer value so we can work with; 1125/525 or 1035/483. Otherwise, the active line ratio should be used. To determine the number of output pixels, we consider the ratio of vertical resampling as well as the fact that the pixels need to be converted to square dimension. The number of output square pixels=( 1512/2×(4.75H/5.55V))×( 1035/483)=1386.5˜1386. FIG. 7 illustrates these numbers.

### Example 2

For PAL the specifications in one advantageous embodiment are as follows:

Active data: 576×742

Pixel dimensions: 4.85 H×4.65 V

FPS: 50 (exactly)

Data stream (input and output) is running at 127.6875 MHz.

Dimensions of Total Input Data (Active and Inactive).

Total number of input lines: 625. To find the total number of pixels per line: in 1 second there are 127.6875×10⁶ pixels. Also, in 1 second there are 50 frames of (625×total number of pixels per input line (127.6875×10⁶/(50×625)=4086.

Dimensions of Total Output Data (Active and Inactive).

Total number of output lines: 1125. We can use the fact that the input and output frame correspond to the same frame time. The total number of pixels per output line is then: (625×4086)/1125=2270.

Dimensions of Active Input Data.

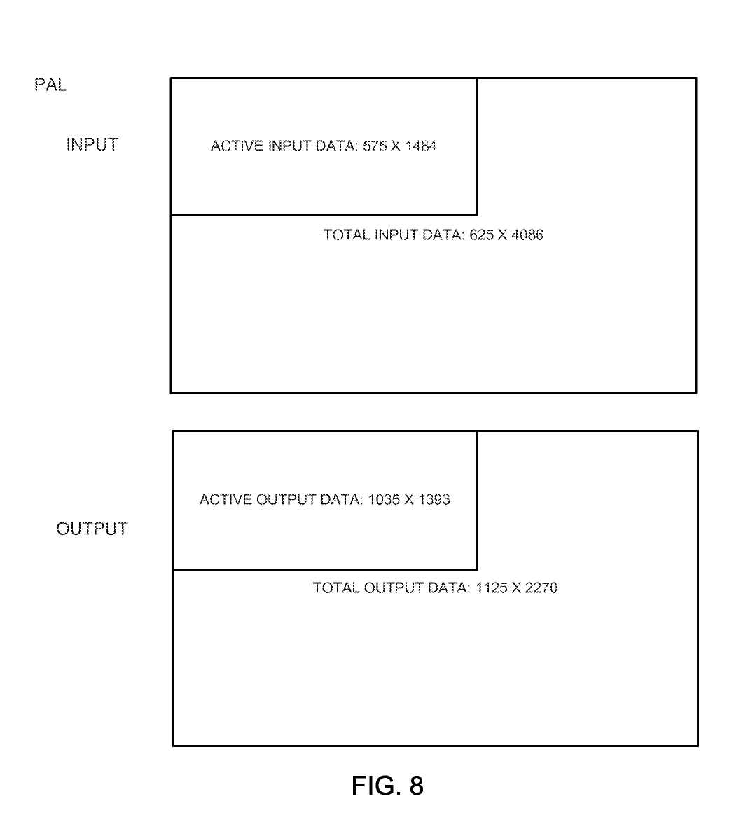

Out of a total of 625 lines, we assume that 573 contain valid data (active lines). The number of input active lines is: 575. The number of pixels per active line is: 742 oversampled by 2=1484. The active lines need to be resampled (vertically) by a factor of 1125/625. The number of output lines is: 575× 1125/625=1035. To determine the number of output pixels, we consider the ratio of vertical resampling as well as the fact that the pixels need to be converted to square dimension. The number of output square pixels=( 1484/2×(4.85H/4.65V))×( 1035/575)=1393. FIG. 8 illustrates these numbers.

In addition to the standard NTSC and PAL SD (NTSC and PAL) composite, RGB, and s-video (Y/C) outputs, numerous other outputs may be used. The following examples are presented to further illustrate and explain the present invention and should not be taken as limiting in any regard.

Serial Digital Interface (SDI), standardized in ITU-R BT.656 and SMPTE 259M, is a digital video interface used for broadcast-grade video. A related standard, known as High Definition Serial Digital Interface (HD-SDI), is standardized in SMPTE 292M and provides a nominal data rate of 1.485 Gbit/s.

Digital Visual Interface (DVI) is a video interface standard designed to maximize the visual quality of digital display devices such as flat panel LCD computer displays and digital projectors and is partially compatible with the HDMI standard in digital mode (DVI-D). The DVI interface uses a digital protocol in which the desired illumination of pixels is transmitted as binary data. When the display is driven at its native resolution, it will read each number and apply that brightness to the appropriate pixel. In this way, each pixel in the output buffer of the source device corresponds directly to one pixel in the display device.

High-Definition Multimedia Interface (HDMI) is an all-digital audio/visual interface capable of transmitting uncompressed streams. HDMI is compatible with High-bandwidth Digital Content Protection (HDCP) Digital Rights Management technology. HDMI provides an interface between any compatible digital audio/video source and a compatible digital audio and/or video monitor, such as a digital television (DTV).

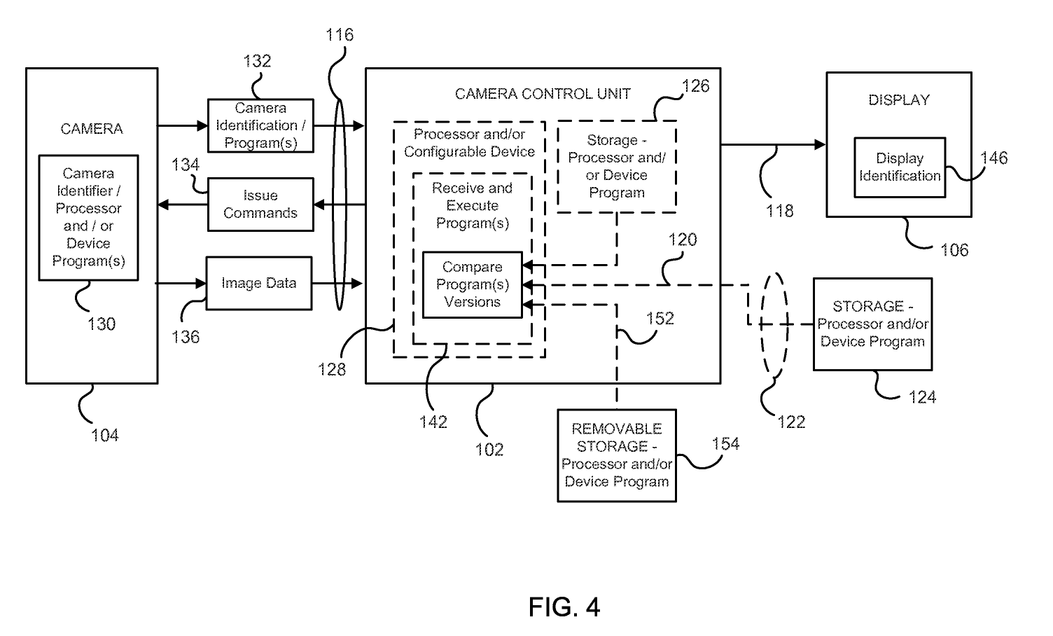

Referring now to FIG. 4 it is contemplated that a storage device for storing the program(s) for configuration of the processor and/or configurable device 128 may reside on camera 104, internal storage 126, a removable storage 154 (e.g. a removable drive or storage medium) or a remote storage 124 (e.g. via a network connection). In this manner, when the camera control unit 102 receives the camera identification/program(s) 132 from camera 104, camera control unit 102 can compare program(s) versions from the various storage mediums to determine if the camera identification/program(s) received from camera 104 is the latest version and if not, the camera information can be updated. This can happen automatically, or the system could, for example, prompt the user to decide whether or not to update the camera information. In addition, it is contemplated that based upon user access, certain programs and/or features may become available.

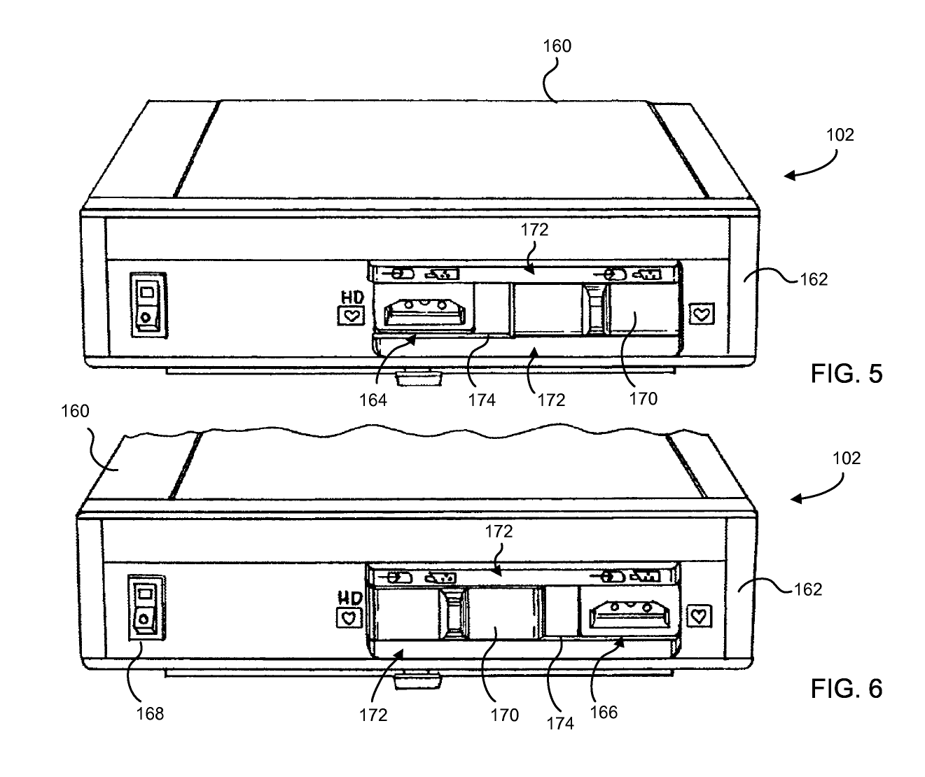

FIGS. 5 and 6 illustrate the camera control unit 102 per one embodiment of the present invention. Camera control unit 102 includes a case 160 having a front panel 162. Front panel 162 is provided with multiple inputs including, an HD receptacle 164 and an SD receptacle 166. In addition, a power switch 168 may also be positioned on front panel 162. Also positioned on front panel 162 is slideable door 170 and tracks 172. It is contemplated that a camera 104 is provided with a plug (not shown) that, based upon the camera configuration (e.g. either HD or SD), is keyed to fit in either HD receptacle 164 or SD receptacle 166. The door 170 may simply be slid to cover the receptacle that is not currently in use. The door is provided with a protrusion(s) (not shown) that engage with a channel 174 provided in tracks 172 so as to capture door 170 but still allow for lateral sliding action.

It should be noted that, while HD receptacle 164 and SD receptacle 166 are not illustrated including an optical connection or coupling, it is contemplated that they may be provided with such.

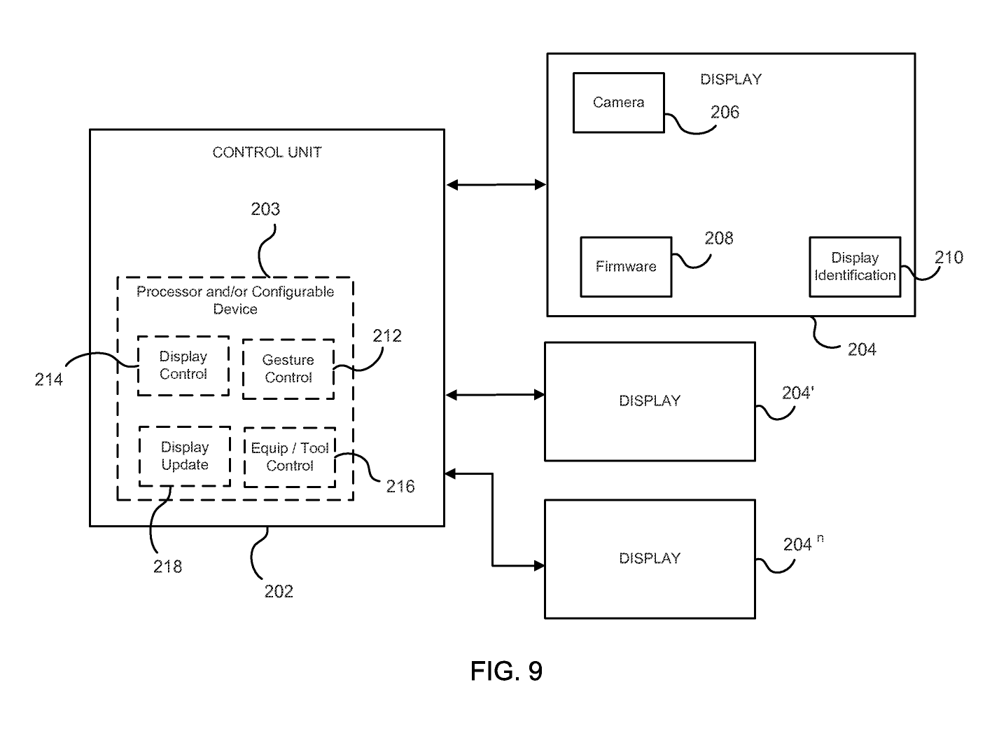

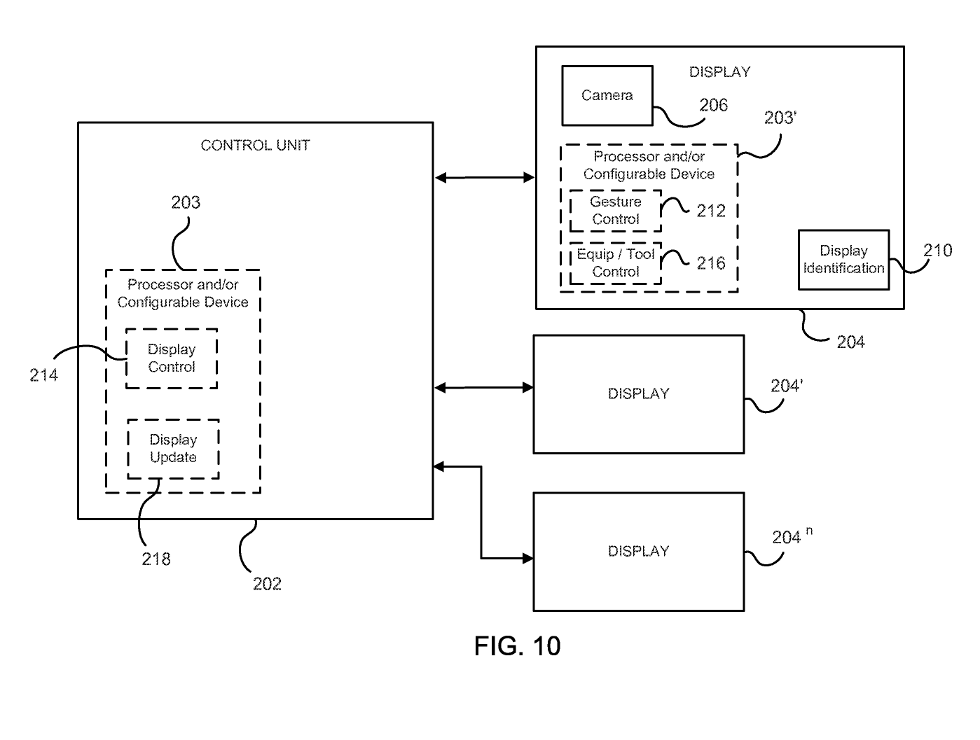

Turning now to FIGS. 9 and 10 control unit 202 including a processor or configurable device 203 is depicted connected to display 204. Display 204 is illustrated with a camera 206, firmware 208 and a display identification 210. It is contemplated that camera 206 maybe integrally built into display 204 such that no external devices are necessary to pick up gestures the surgeon may make to control the system. Firmware 208 may be saved onto display 204 providing the appropriate functionality for control of the display and for transfer of control information to the control unit 202. Likewise, display identification 210 may comprise data that is transmitted to control unit 202 identifying the connected display 204 so that the control unit 202 can configure itself to properly function with display 204.

The gesture control functionality provided by the system may utilize a distance sensing element that may comprise in one embodiment, camera 206, to pick up hand gestures performed by a user to control various aspects of the surgical system. For example, the user may desire to change a setting of the display 204, such as changing a brightness setting. This could be accomplished by the user performing a hand gesture in front of the camera 206 thereby bringing up a menu allowing the user to adjust the brightness of the display 204 as desired without the need of actually physically touching the display 204. The gesture made by the user could be captured by the camera 206 and interpreted by the firmware 208 to generate gesture data, which could then be transmitted to control unit 202 (in FIG. 10 a processor 203′ located in display 204 includes gesture control 212 and equip/tool control 216). Gesture control 212 is provided on control unit 202 that receives the gesture data and then generates a control signal(s) to carry out the command corresponding to the gesture made by the user. For example, in the example provided above, the gesture may correspond to a command to change the brightness of the display 204. The gesture made by the user would be interpreted and sent to gesture control 212. A control signal could then be generated by gesture control 212 and sent to display control 214, which could then generate a control signal that will adjust the brightness level in accordance with the inputted gesture(s). It is contemplated that camera 206 may comprise, for example, an infrared or ultrasonic camera. Alternatively, the system may utilize laser time of flight measurement, or may utilize microwave distance sensing.

Likewise, the user may decide to adjust a setting of a piece of surgical equipment, such as an irrigation device (not shown). A gesture made by the user could be picked up by the camera 206, interpreted and sent to gesture control 212. Gesture control 212 could then transmit a control signal to Equip/Tool control 216 to adjust the irrigation device in accordance with the inputted gesture by the user. It should be noted that display 204′ and display 204ⁿ are depicted in FIG. 9. These displays may comprise auxiliary displays to display 204, which may comprise a main surgical display. For example, in the above situation where the user adjusted the setting of an irrigation device, the current setting of the irrigation device may be presented on display 204′ positioned adjacent to the user (surgeon). Display 204′ is provided with a camera, firmware and display identification in the same manner as display 204, such that the user can control the system via gesture control as previously discussed. However, rather than presenting image data from the surgical area as the main display 204, display 204′ may display the current settings or status of various medical equipment and tools. In order to adjust any of the settings, the user need only make the correct hand gestures in front of display 204′ to adjust any of the medical equipment and tools being used.

It is further contemplated that display 204 and/or display 204′ may comprise a port (e.g., a USB port or the like) that allows for the display or any equipment connected to the display (e.g., the control unit 202, the camera 206, other displays, or any equipment connected to the surgical system via a network or bus connection) to be updated, for example, with a program. In one example, a user could insert a USB drive into a USB port and update or overwrite virtually any device or system file that is connected to the display through the control unit 202, which is connected to a network.

Likewise, display 204ⁿ may comprise yet another display in the operating room that presents various data to, for example, an anesthesiologist and may or may not be equipped for gesture control. The display 204ⁿ may present various information to the anesthesiologist including patient vital signs, insufflation setting(s), anesthesia setting(s) and so on. It is contemplated that any number of displays may be connected to control unit 202. For example, another display could be connected for instruction (such as are used in teaching hospitals) so that medical students in a nearby location can view the surgical procedure. Alternatively, the image data could be transmitted to a remote location, such as a medical school classroom for instructional purposes or even to a remote location for a collaborating surgeon to see and provide input to the surgeon performing the procedure. Still further, additional displays could be provided in differing locations in the operating room as desired.

As another example, a user (surgeon) may desire to adjust a setting of a medical tool (not shown), such as a cauterization cutting device. The user could then perform the requisite hand gesture in from of, for example, display 204′, which would pick up the gesture, interpret it and send the data to gesture control 212. Gesture control 212 would then generate the appropriate control signal to send to Equip/Tool control 216, which in turn would allow for the adjustment to the setting of the cauterization cutting device. It should be understood that the system will have safeguards in place such that no adjustment of a piece of equipment or tool will occur accidentally including asking the user to confirm that an adjustment is to occur when a gesture command is received.

In still another example, the user (surgeon) may decide that a still frame picture or a video clip of an area that is presented on the main surgical monitor should be captured and saved. The user may make the appropriate hand gesture in front of display 204 to capture and route the image data. Alternatively, display 204′ may also display the image data of the surgical area (e.g. in a window apart from the equipment and/or tool settings or as an overlay, etc.). The user could then input the hand gesture to display 204′ to capture and route the image data as desired. The idea is to provide maximum versatility for the user to control the surgical system whether it be via the main surgical display 204 or via any of the other surgical displays 204′, 204ⁿ without needing to physically touch any of the devices.

The benefit of the above system is that it allows the user maximum control of the system, but does not require that the displays sterilized as the user never comes into contact with the displays. This would obviate the need for a user to re-sterilize their hands if an adjustment were required an one of the displays needed to be physically touched.

Also depicted in FIGS. 9 and 10 is display update 218, which may be provided to update the firmware 208 as necessary. It is contemplated that control unit 202 may be connected to a network such that remote updating of the control unit 202 or any of the displays 204, 204′, 204ⁿ could be accomplished, for example, when the displays 204, 204′, 204ⁿ were not in use.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A surgical system comprising:
a camera for generating image data;
a control unit connected to said camera, wherein said control unit is configured to function with at least two different displays, each of the at least two different displays having differing input signal requirements and each of the at least two different displays having a storage including a display identifier identifying the respective display;
wherein upon connection of said control unit with one of the at least two different displays, said control unit automatically determines a compatible output signal format for the connected display and configures itself accordingly.

2. The system according to claim 1 wherein upon connection of said display to said control unit, a program is received by said control unit.

3. The system according to claim 1 wherein the output signal format is selected from the group consisting of: NTSC, PAL, Serial Digital Interface (SDI), High Definition Serial Digital Interface (HD-SDI), Digital Visual Interface (DVI), High-Definition Multimedia Interface (HDMI) and combinations thereof.

4. The system according to claim 1 wherein upon connection of said camera to said control unit, said control unit receives a camera identifier identifying the connected camera and said control unit configures itself to be compatible with said connected camera.

5. The system according to claim 1 wherein said control unit further comprises a first input for receiving image data having a first signal format and a second input for receiving image data having a second signal format that is different from said image data having the first signal format.

6. The system according to claim 1 wherein one of said at least two displays includes a display camera.

7. The system according to claim 6 wherein said display camera is mounted within a housing of the one of said at least two displays.

8. The system according to claim 6 wherein the control unit comprises a gesture control module and the camera picks up gestures made to control the system.

9. The system according to claim 8 wherein the gesture control module allows capturing and saving of image data.

10. The system according to claim 9 wherein the gesture control module allows routing of the image data to a storage location.

11. The system according to claim 8 wherein the gesture control module allows capturing and saving of audio data.

12. The system according to claim 8 further comprising an equipment/tool control module and wherein the gesture control module allows control of surgical equipment or surgical tools.

13. The system according to claim 12 wherein the gesture control module allows control of operating room equipment.

14. The system according to claim 8 wherein both of said at least two displays include respective cameras and the cameras in each of the two displays each pick up respective gestures to control different functions of the system.

15. The system according to claim 14 comprising a third display coupled to the system.

16. The system according to claim 6 wherein the control unit comprises a display control module

17. The system according to claim 16 wherein the display control module allows for adjustment of display control settings for one of said at least two displays.

18. The system according to claim 6 wherein one of said at least two displays includes firmware stored on the storage and the control unit comprises a display update module that updates the firmware.

19. The system according to claim 1 further comprising a distance sensing element selected from the group consisting of: an infrared sensor, an ultrasonic sensor, a laser time of flight sensor a microwave distance sensor and combinations thereof.

20. The system according to claim 1 wherein said connected display includes a port that allows for updating of equipment connected to said display.

20. A surgical system comprising:
a camera for generating image data;
a display for displaying the image data, said display having a storage with a display identifier saved therein;
said display having a camera located therein;
a control unit having a gesture control module, said control unit coupling said camera to said display;
wherein upon connection of said control unit with said display, said control unit automatically determines a compatible output signal format for said connected display and configures itself accordingly; and
said camera picks up gestures made to control the system.

21. The system according to claim 21 wherein capturing and saving of image data is controlled by the gesture control module.

22. The system according to claim 22 wherein the routing of the image data to a storage location is controlled by the gesture control module.

23. The system according to claim 21 wherein capturing and saving of audio data is controlled by the gesture control module.

24. The system according to claim 21 further comprising an equipment/tool control module and wherein control of surgical equipment or surgical tools is controlled by the gesture control module.

25. The system according to claim 21 comprising two displays coupled to said control unit, where each display includes a respective camera and each camera picks up respective gestures to control different functions of the system.

26. The system according to claim 21 wherein the control unit comprises a display control module wherein adjustment of display control settings for said display is controlled by the display control module.

27. The system according to claim 21 wherein said camera comprises an infrared or ultrasonic camera.

28. The system according to claim 21 wherein said camera utilizes a distance sensing element selected from the group consisting of: an infrared sensor, an ultrasonic sensor, a laser time of flight sensor, or a microwave distance sensor, and combinations thereof.

29. The system according to claim 21 wherein said connected display includes a port that allows for updating of equipment connected to said display.
